(19) United States
(12) Patent Application Publication
(10) Pub. No.: US 2025/0225964 A1
(43) Pub. Date: Jul. 10, 2025

(54) REPETITION DETERMINATION DEVICE, METHOD, AND PROGRAM

(71) Applicant: Yamaha Corporation, Hamamatsu (JP)

(72) Inventor: Hiroki TSUZUKI, Hamamatsu (JP)

(21) Appl. No.: 19/011,743

(22) Filed: Jan. 7, 2025

(30) Foreign Application Priority Data
Jan. 9, 2024 (JP) 2024-001155

(51) Int. Cl. G10H 1/34; G10H 1/043

(52) U.S. Cl. CPC G10H 1/34; G10H 1/043

(57) ABSTRACT

A repetition determination device includes an electronic controller including at least one processor configured to execute a first acquisition unit configured to acquire note-on events and a note-off event as note events corresponding to key operations, a second acquisition unit configured to acquire a pedal-on event and a pedal-off event as pedal events corresponding to operations of a pedal having a function of sustaining sound, and a determination unit configured to determine, based on a time interval between acquisition of a first note-on event and acquisition of a second note-on event, the note-off event, the pedal-on event, and the pedal-off event, whether the second note-on event corresponds to repetition of the same note with respect to the first note-on event. The first note-on event and the second note-on event are successive and related to the same note among the note-on events that have been acquired.

### CROSS-REFERENCE TO RELATED APPLICATIONS

This application claims priority to Japanese Patent Application No. 2024-001155, filed on Jan. 9, 2024. The entire disclosure of Japanese Patent Application No. 2024-001155 is hereby incorporated herein by reference.

### BACKGROUND

### Technical Field

The present invention relates to a repetition determination device, method, and program.

### Background Information

Technology that is applied to electronic instruments to produce more natural sounds when repetition of the same note is played is known. For example, in Japanese Patent No. 7215523, Japanese Patent No. 7298650, and Japanese Patent No. 4167786, the sound decay rate, pitch, timbre, volume of the second sound, etc., are controlled on the basis of the amplitude ratio between a first sound and a second sound, which have a repetition relationship.

In addition, Japanese Laid Open Patent Application No. Hei 05(1993)-2392 and Japanese Laid Open Patent Application No. Hei 05(1993)-6181 disclose examples in which repetition (repeated note) is determined on the basis of whether it is during the attack.

### SUMMARY

However, for example, in the case of an acoustic keyboard instrument, particularly for sounds having the same pitch, there are cases in which not only key operations but also the combination of the timing of the key operation and the state of the pedal is involved in the repetition relationship. Accordingly, there is room for improvement in terms of more appropriately determining repetition of the same pitch.

One object of this disclosure is to provide a repetition determination device that can appropriately determine repetition of the same note.

According to one embodiment of this disclosure, a repetition determination device comprises an electronic controller including at least one processor configured to execute a first acquisition unit, a second acquisition unit, and a determination unit. The first acquisition unit is configured to acquire note-on events and a note-off event as note events corresponding to key operations. The second acquisition unit is configured to acquire a pedal-on event and a pedal-off event as pedal events corresponding to operations of a pedal having a function of sustaining sound. The determination unit is configured to determine, based on a time interval between acquisition of a first note-on event and acquisition of a second note-on event, the note-off event, the pedal-on event, and the pedal-off event, whether the second note-on event corresponds to repetition of the same note with respect to the first note-on event. The first note-on event and the second note-on event are successive and related to the same note among the note-on events that have been acquired.

### BRIEF DESCRIPTION OF THE DRAWINGS

FIG. 1 is a block diagram of an electronic keyboard instrument to which a repetition determination device is applied.

FIG. 2 is functional block diagram of an electronic keyboard instrument for implementing a repetition determination process.

FIG. 3 is a timing chart showing a pattern when determining repetition of the same note.

FIG. 4 is a timing chart showing a pattern when determining repetition of the same note.

FIG. 5 is a timing chart showing a pattern when determining repetition of the same note.

FIG. 6 is a timing chart showing a pattern when determining repetition of the same note.

FIG. 7 is a flowchart of the repetition determination process.

FIG. 8 is a diagram showing a flow of signals for realizing a prescribed sound control.

### DETAILED DESCRIPTION OF THE EMBODIMENTS

Selected embodiments will now be explained with reference to the drawings. It will be apparent to those skilled in the field from this disclosure that the following descriptions of the embodiments are provided for illustration only and not for the purpose of limiting the invention as defined by the appended claims and their equivalents.

Embodiments of this disclosure are described below with reference to the drawings.

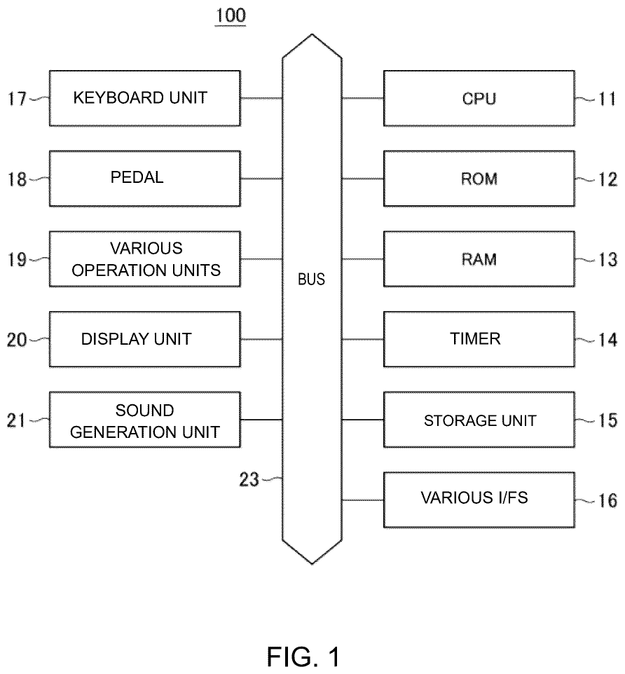

FIG. 1 is a block diagram of an electronic keyboard instrument to which a repetition determination device according to one embodiment of this disclosure is applied.

This electronic keyboard instrument 100 is configured by each element being connected to a CPU (Central Processing Unit) 11 via a bus 23. The electronic keyboard instrument 100 comprises a ROM 12 (Read-Only Memory), a RAM (Random Access Memory) 13, a timer 14, a storage unit 15, and various interfaces (I/Fs) 16.

The ROM 12 stores a control program executed by the CPU 11. The CPU 11 is one example of at least one processor included in an electronic controller. The CPU 11 deploys the control program stored in the ROM 12 in the RAM 13 and executes the program to realize various functions. The term “electronic controller” as used herein refers to hardware that executes software programs. The electronic controller can be configured to comprise, instead of the CPU 11 or in addition to the CPU 11, programmable logic devices such as a DSP (Digital Signal Processor), an FPGA (Field Programmable Gate Array), and the like. In addition, the electronic controller can include a plurality of CPUs (or a plurality of programmable logic devices).

The storage unit 15 is nonvolatile memory. The storage unit 15 stores various pieces of information and setting information. The various I/Fs 16 include MIDI I/F that sends and receives Musical Instrument Digital Interface (MIDI) signals. The various I/Fs 16 can include a communication I/F that connects to a communication network by wire or wirelessly.

The electronic keyboard instrument 100 also includes a keyboard unit (keyboard) 17, a pedal 18, a various operations unit 19, a display unit (display) 20, and a sound generation unit (sound generator) 21. The keyboard unit 17 and the pedal 18 are elements for inputting performance signals.

The keyboard unit 17 includes a plurality of keys as well as sensors and detection circuits that detect operations of each key (none shown). The pedal 18 include one or more pedals as well as sensors and detection circuits that detect operations of said pedals (none shown). The pedal 18 include at least a pedal having a function of sustaining sound, such as a damper pedal or a sostenuto pedal.

Performance signals that have been input are sent to the CPU 11 as MIDI signals (event data conforming to the MIDI standard). MIDI signals relating to keys include information such as a note number indicating the pitch, note on, note off, note-on velocity, note-off velocity, and the like. MIDI signals relating to pedals include information such as pedal on and pedal off.

An MIDI signal is control information for instructing processing related to sound, and is, for example, event data such as note on, note off, program change, pitch bend change, and control change. The foregoing can simply be referred to as “events” in the description below.

The various operations unit 19 includes a plurality of operators (not shown) for inputting various information, and receives instructions from a user. The display unit 20 displays various information. The sound generation unit 21 includes a sound source circuit, an effects circuit, and a sound system (none shown). While details will be described further below, the sound generation unit 21 has a function of correcting sound characteristics, on the basis of events, in sound control carried out by the CPU 11.

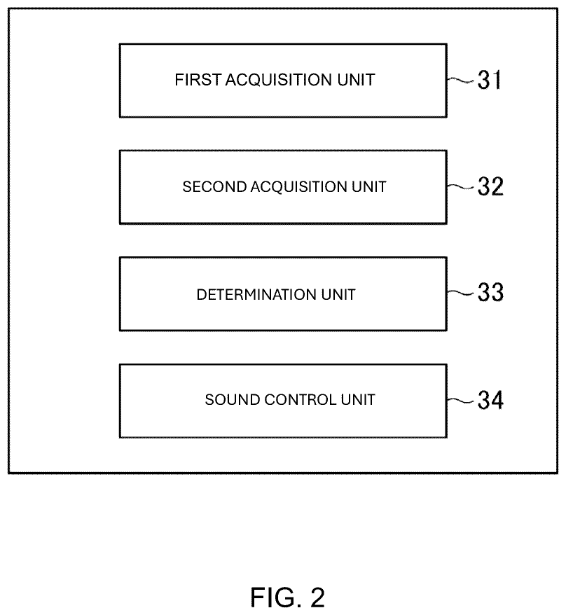

FIG. 2 is functional block diagram of the electronic keyboard instrument 100 for implementing a repetition determination process. The electronic keyboard instrument 100 includes, as functional units, a first acquisition unit 31, a second acquisition unit 32, a determination unit 33, and a sound control unit 34. The function of each of these functional units is realized by cooperation between the CPU 11, the ROM 12, the RAM 13, the timer 14, the sound generation unit 21, the various I/Fs 16, and the like. If the function of “prescribed sound control,” described further below, is not required, it is not essential to provide the sound control unit 34.

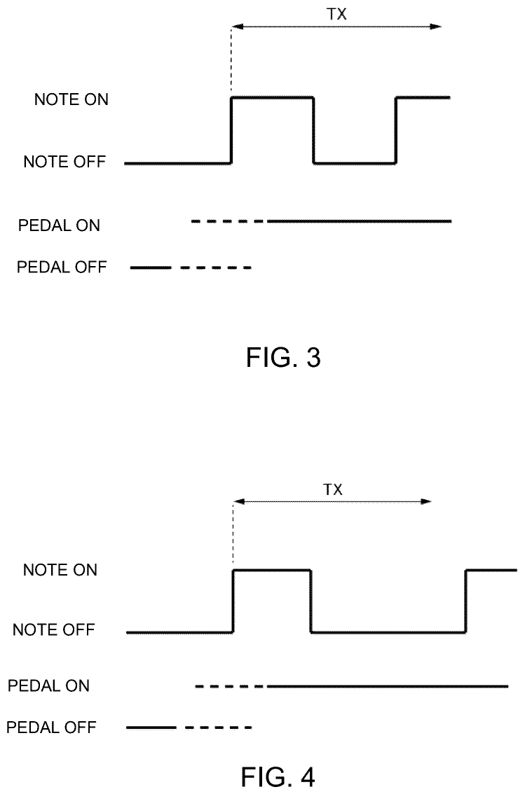

In sum, when the same key is successively pressed within a prescribed period of time TX (for example, three seconds; FIGS. 3-6) and a prescribed condition is met, it is determined, in principle, to be repetition of the same note. In the present embodiment, the repetition of the same note is determined also in consideration of the operation of the pedal 18. The repetition of the same note is, for example, repetition of the same pitch.

However, events used for determination are not limited to events acquire forced by actual operations of the keyboard unit 17 and the pedal 18, and can be events acquired from the outside via the various I/Fs 16. Alternatively, a series of MIDI data stored in the storage unit 15 can be acquired and analyzed to determine the repetition of the same note.

The first acquisition unit 31 acquires note-on events and one or more note-off events as note events corresponding to operations of each key of the keyboard unit 17.

The second acquisition unit 32 acquires one or more pedal-on events and one or more pedal-off events as pedal events corresponding to operations of the pedal 18.

The determination unit 33 determines, on the basis of a time interval between acquisition of a first note-on event (earlier note-on event of two successive note-on events) and acquisition of a second note-on event (later note-on event of the two successive note-on events) that are successive and related to the same note among the acquired note-on event events, the note-off event, the pedal-on event, and the pedal-off event, whether the second note-on event corresponds to the repetition of the same note with respect to the first note-on event.

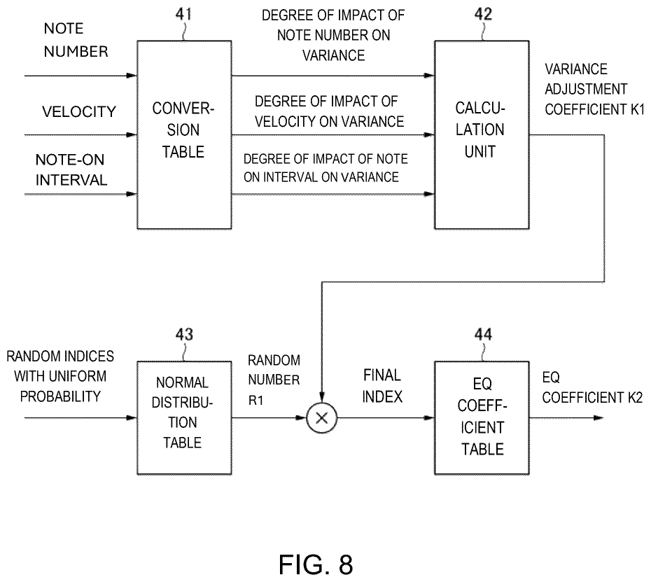

Regarding the sound control based on the second note-on event, when the second note-on event is determined to correspond to the repetition of the same note, the sound control unit 34 executes a “prescribed sound control” that is different from a sound control (normal sound control) that is executed when the second note-on event is determined not to correspond to the repetition of the same note. The normal sound control is a control in which sound is turned on or off with no change from the set sound characteristics. In the prescribed sound control, the sound characteristics are corrected, as will be described further below with reference to FIG. 8.

FIGS. 3-6 are timing charts showing patterns when determining the repetition of the same note from events that are input.

First, regarding the state of the pedal 18, the determination unit 33 determines a state in which a pedal-off event is not acquired after acquiring a pedal-on event to be a “pedal-on state,” corresponding to a state in which the pedal 18 is being depressed. The determination unit 33 determines any other state to be a “pedal-off state,” corresponding to as a state in which the pedal 18 is not depressed.

In the example of FIG. 3, a note-off event is acquired between the first note-on event and the second note-on event. In addition, the second note-on event is acquired within the prescribed period of time TX from the acquisition of the first note-on event. That is, the time interval between the first and second note-on events is within the prescribed period of time TX. On the other hand, the pedal is in the pedal-on state at the time of acquisition of the note-off event and at the time of acquisition of the second note-on event. In this case, the second note-on event is determined to correspond to the repetition of the same note.

That is, the determination unit 33 determines that the second note-on event corresponds the repetition of the same note when the note-off event after the first note-on event is acquired in the pedal-on state, and the second note-on event is acquired while still in the pedal-on state before the prescribed period of time TX has elapsed since the acquisition of the first note-on event. The acquisition timing of the pedal-on event can be any time before the note-off event that occurs after the first note-on event, and can be either before or after the first note-on event.

In the example of FIG. 4, the note-off event is acquired between the first note-on event and the second note-on event. In addition, the second note-on event is acquired after the prescribed period of time TX has elapsed since the acquisition of the first note-on event. In this case, even though the note-off event and the second note-on event are acquired in the pedal-on state, the second note-on event is determined not to correspond to the repetition of the same note. Note that there is no restriction on whether the pedal-on event occurs before or after the first note-on event.

That is, the determination unit 33 determines that the second note-on event does not correspond to the repetition of the same note when the note-off event that occurs after the first note-on event is acquired in the pedal-on state, and the second note-on event is acquired after the prescribed period of time TX has elapsed since the acquisition of the first note-on event.

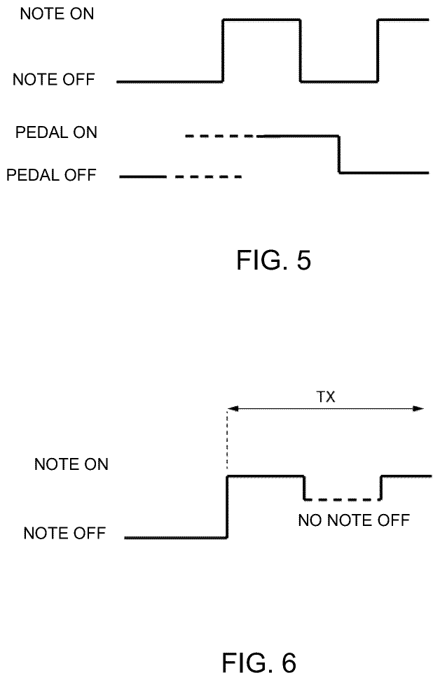

In the example of FIG. 5, the note-off event is acquired between the first note-on event and the second note-on event. However, the pedal is in the pedal-off state at the time of acquisition of the second note-on event. In this case, the second note-on event is determined not to correspond to the repetition of the same note.

That is, the determination unit 33 determines that the second note-on event does not correspond to the repetition of the same note when the note-off event that occurs after the first note-on event is acquired in the pedal-on state, and the second note-on event is acquired after the pedal enters the pedal-off state. Note that there is no restriction on whether the pedal-on event occurs before or after the first note-on event.

In the example of FIG. 6, the note-off event is not acquired between the first note-on event and the second note-on event. In addition, the second note-on event is acquired within the prescribed period of time TX from the acquisition of the first note-on event. This corresponds to a case in which a key is repeatedly depressed in short succession in a deeply depressed position. In this case, the second note-on event is determined to correspond to the repetition of the same note regardless of the state of the pedal.

That is, the determination unit 33 determines that the second note-on event corresponds to the repetition of the same note when a note-off event is not acquired after the first note-on event, and the second note-on event is acquired before the prescribed period of time TX has elapsed since the acquisition of the first note-on event. Accordingly, it is possible to determine the repetition of the same note without an intervening note-off event.

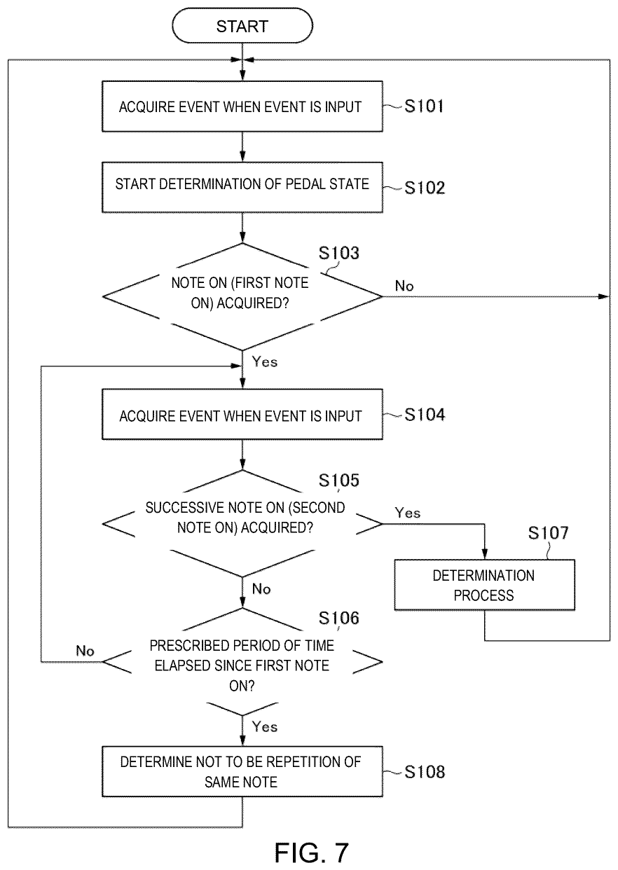

FIG. 7 is a flowchart of the repetition determination process. This process starts when the power of the electronic keyboard instrument 100 is turned on and ends when the power is turned off, for example.

In step S101, the CPU 11 monitors input of events (note events and pedal events), acquires the event when an event is input, and skips the process when an event is not input. In step S102, the CPU 11 starts determination of the pedal state on the basis of the last acquired pedal event. Thereafter, the pedal state is determined and the determination result is updated each time a pedal event is newly acquired.

In step S103, the CPU 11 determines whether a note-on event was acquired in step S101. The note-on event acquired in step S101 is the “first note-on event.” When a note-on event is acquired, the CPU 11 starts measuring the time elapsed from the time of acquisition of said note-on event using the timer 14.

As a result of the determination in step S103, the CPU 11 returns to step S101 if a note-on event has not been acquired, and proceeds to step S104 if a note-on event has been acquired.

In step S104, the CPU 11 monitors input of events, acquires the event when an event is input, and skips the process when an event is not input. In step S105, the CPU 11 determines whether a successive note-on event (related to the same pitch) following a first note-on event has been acquired in step S104. The note-on event acquired in step S104 is the “second note-on event.”

As a result of the determination in step S105, when the second note-on event has not been acquired, the CPU 11 determines, in step S106, whether the prescribed period of time TX has elapsed since acquisition of the first note-on event. Then, the CPU 11 returns to step S104 when the prescribed period of time TX has not elapsed since the acquisition of the first note-on event. However, when the prescribed period of time TX has elapsed since the acquisition of the first note-on event, the CPU 11 proceeds to step S108.

In step S018, the CPU 11 determines that the current second note-on event does not correspond to the repetition of the same note with respect to the first note-on event. For example, as shown in FIG. 4, when the prescribed period of time TX has elapsed between acquisition of the first note-on event and acquisition of the second note-on event, the current second note-on event is determined not to correspond to the repetition of the same note regardless of the pedal state. This is regardless of whether the note-off event has been acquired between the acquisition of the first note-on event and the acquisition of the second note-on event. In addition, if we modify a part of FIG. 6 and assume that the prescribed period of time TX has elapsed between the acquisition of the first note-on event and the acquisition of the second note-on event without acquisition of the note-off event, the second note-on event is determined not to correspond to the repetition of the same note. After step S108, the CPU 11 returns to step S101.

As a result of the determination in step S105, if the second note-on event has been acquired, the CPU 11 executes the determination process in step S107. In this determination process, whether it is the repetition of the same note is determined on the basis of the time interval between the acquisition of the first note-on event and the acquisition of the second note-on event, the note-off event, the pedal-on event, and the pedal-off event.

For example, as in the example shown in FIG. 3, the second note-on event is determined to correspond to the repetition of the same note when the note-off event that occurs after the first note-on event is acquired in the pedal-on state, and the second note-on event is acquired while still in the pedal-on state before the prescribed period of time TX has elapsed since the acquisition of the first note-on event.

In addition, as in the example shown in FIG. 6, the second note-on event is also determined to correspond to the repetition of the same note when the note-off event is not acquired after the first note-on event, and the second note-on event is acquired before the prescribed period of time TX has elapsed since the acquisition of the first note-on event.

However, as in the example shown in FIG. 5, the second note-on event is determined not to correspond to the repetition of the same note when the note-off event that occurs after the first note-on event is acquired in the pedal-on state, and a second note-on event is acquired after the pedal enters a pedal-off state. After the determination process, the CPU 11 returns to step S101.

In should be noted that the determination process (S107) can be configured to be able to determine the repetition of the same note of three or more successive notes. In such a case, the process returns to step S101 after the prescribed period of time TX has elapsed since the acquisition of the last note-on event. When, before the prescribed period of time TX has elapsed since the acquisition of the last note-on event, the next note-on event is acquired, whether the next note-on event corresponds to the repetition of the same note with respect to the last note-on event can be determined by applying the types shown in FIGS. 3-6. That is, a process corresponding to steps S104 to S106 can be executed until the prescribed period of time TX has elapsed since the last note-on event. Accordingly, when the last note-on event is considered to be the first note-on event and the next note-on event is considered to be the second note-on event, if the two events have the relationship of the repetition of the same note, it can be determined as the repetition of the same note of three or more successive notes.

The prescribed sound control will be described next. The prescribed sound control can also be applied to real-time performance processing, in which sounds are generated in conjunction with a performer's operation of the keyboard unit 17.

FIG. 8 is a diagram showing a flow of signals that realize the prescribed sound control. When it is determined to be the repetition of the same note, the prescribed sound control is applied to a sound control based on the note-on event that is determined to be the repetition of the same note (the second note-on event in the case of two successive notes). For example, in this sound control, equalizer characteristics are controlled for the purpose of achieving a more natural timbre variation.

The method of determining the repetition of the same note when this prescribed sound control is applied is not limited to the example described above. That is, the prescribed sound control can be applied when it is determined to be the repetition of the same note by other methods, including known methods. While the timing of execution of the prescribed sound control is not limited, the control can be started in response to the determination of the repetition of the same note, for example.

A conversion table 41, a normal distribution table 43, and an EQ coefficient table 44 are stored in the storage unit 15 in advance. The functions of the calculation unit 42 are realized by cooperation between the CPU 11, the ROM 12, the RAM 13, and the like. The determination of the value in each table as well as the calculation of values by the calculation unit 42 are controlled by the sound control unit 34 (FIG. 2).

Information such as the note number, velocity, and note-on interval of each note event is input to the conversion table 41. Velocity includes note-on velocity and note-off velocity. A note-on interval is the time interval between the acquisition of the first note-on event and the acquisition of the second note-on event, as described above.

The conversion table 41 converts the information that has been input into a degree of impact on variance, and outputs the degree of impact to the calculation unit 42. The degree of impact is output for each of the note number, velocity, and note-on interval.

In the prescribed sound control, the sound control unit 34 uses a variance adjustment coefficient K1 (correction value) calculated by the calculation unit 42 to correct the sound characteristics. The variance adjustment coefficient K1 corresponds to standard deviation, and is calculated as one of a plurality of levels (for example, 10 levels). When causing the calculation unit 42 to calculate the variance adjustment coefficient K1, the sound control unit 34 uses the conversion table 41 to determine the degree of impact of each element to the variance adjustment coefficient KI as follows. For example, the sound control unit 34 executes at least one or more of the following (a), (b), (c), (d) or (c).
(a) Increase the degree of impact of the note number as the note number decreases
(b) Increase the degree of impact of velocity as the note-on velocity of the first note-on event increases
(c) Increase the degree of impact of velocity as the note-on velocity of the second note-on event increases
(d) Increase the degree of impact of velocity as the difference between the note-on velocity of the first note-on event and the note-on velocity of the second note-on event increases
(3) Increase the degree of impact of the note-on interval as the note-on interval decreases

The calculation unit 42 calculates the variance adjustment coefficient K1 on the basis of each degree of impact input from the conversion table 41. Each degree of impact can be weighted.

Random indices with uniform probability are input to the normal distribution table 43. The normal distribution table 43 generates a random number RI with respect to this input. The random number R1 is generated using a normal (Gaussian) distribution, resulting in random timbre variations that, moreover, achieve naturally coherent timbre variations similar to those found in natural phenomena.

A final index is obtained by multiplying the random number R1 by the variance adjustment coefficient K1, and this final index is input to the EQ coefficient table 44. The EQ coefficient table 44 generates and outputs an EQ coefficient K2 on the basis of the final index that has been input. Here, as an example, the final index is a scalar value for selecting the EQ coefficient K2, and the EQ coefficient K2 is implemented as a filter coefficient of an Infinite Impulse Response (IIR) filter.

The sound control unit 34 uses the EQ coefficient K2 that has been output and controls the equalizer characteristics in the sound generation of the second note-on event to realize a prescribed sound control that is different from normal sound control. With this control, it is possible to appropriately reproduce timbre variations similar to those of acoustic keyboard instruments at the time of repetition of the same note, thereby enhancing the expressive power.

The equalizer characteristics can be made variable for each of a plurality of divided frequency ranges (bands). For example, the frequency range can be divided into a plurality of (for example, three) bands using a plurality of center frequencies, and a random number R1 can be generated for each of the frequency bands to determine the EQ coefficient K2 for each frequency band. In this manner, the expressive power can be further enhanced.

When making the equalizer characteristics variable for each of a plurality of divided frequency bands, the number of center frequencies and frequency bands can be changed based on random numbers.

From the viewpoint of enhancing the expressive power, the sound control unit 34 is not limited to controlling equalizer characteristics in the prescribed sound control, and can control one or more of equalizer characteristics, attack waveform, and volume characteristics (velocity characteristics). In this case, the attack waveform or the volume characteristics can be determined using a random number. For example, a plurality of patterns of attack waveforms or volume characteristics can be stored, a random number range can be divided into a plurality of ranges, and an attack waveform or volume characteristics that corresponds to the range in which a generated random number belongs can be employed.

When it is determined to be repetition of the same note of three or more successive times, a parameter can be added in accordance with the number of successive strikes to change the sound characteristics. For example, for the third sound, the second sound can be multiplied by a coefficient based on yet another parameter, or by a newly generated random number, to make the third sound characteristics different from the second sound characteristics.

From the viewpoint of realizing a prescribed sound control regardless of the method of determining the repetition of the same note, the electronic keyboard instrument 100 can include, as functional units, an acquisition unit similar to the first acquisition unit 31 shown in FIG. 2, a determination unit taking the place of the determination unit 33, and a control unit taking the place of the sound control unit 34. The function of each of these functional units is realized by cooperation between the CPU 11, the ROM 12, the RAM 13, the timer 14, the sound generation unit 21, the various I/Fs 16, and the like.

First, the acquisition unit described above acquires note-on events and note-off events as note events corresponding to the operations of the keys. The determination unit described above determines whether a second note-on event corresponds to the repetition of the same note with respect to a first note-on event, relating to successive same notes among the acquired note-on events. Regarding sound control based on the second note-on event, when it is determined to be the repetition of the same note, the control unit described above executes a prescribed sound control that is different from the sound control that is executed when the second note-on even is determined not to correspond to the repetition of the same note. In addition, in the prescribed sound control, the control unit described above uses a random number corresponding to the variance set based on the correction value to correct the sound characteristics.

For example, in FIG. 8, let us assume that the variance adjustment coefficient K1 is the “correction value,” the product of the random number R1 (random number following a normal distribution) and the variance adjustment coefficient K1 is the “value corresponding to a random number following a normal distribution with corrected variance,” and the EQ coefficient K2 is the “filter coefficient (n numbers) corresponding to EQ.” In this case, the control unit described above uses the “random number” corresponding to the “variance” set based on the “correction value” to correct the sound characteristics

According to the present embodiment, it is determined whether the second note-on event corresponds to the repetition of the same note with respect to the first note-on event on the basis of the note-on interval, the note-off event, the pedal-on event, and the pedal-off event. Accordingly, since the repetition of the same note is determined in consideration of the relationship with the pedal state, it is possible to appropriately determine the repetition of the same note.

In addition, according to the present embodiment, when the second note-on event is determined to correspond to the repetition of the same note, a prescribed sound control that is different from the sound control that is executed when the second note-on event is determined not to correspond to the repetition of the same note is executed. Accordingly, it is possible to reproduce timbre variations at the time the second note-on event of the repetition of the same note, thereby enhancing the expressive power.

This disclosure can be applied to a process for reducing the number of simultaneously generated sounds. For example, some sounds generated in a sound generation channel that are in a repetition relationship can be stopped on the basis of a determination result of the repetition of the same note.

The device to which the repetition determination device of this disclosure is applied is not limited to electronic keyboard instruments, or to devices with a sound generating function.

At least some of the functional units shown in FIGS. 2 and 8 can be realized by artificial intelligence (AI).

This disclosure was described above based on preferred embodiments, but this disclosure is not limited to the above-described embodiments, and includes various embodiments that do not depart from the scope of the invention.

A storage medium that stores a control program represented by software for achieving this disclosure can be read into the present instrument to achieve the same effects of this disclosure, in which case the program code read from the storage medium realizes the novel functions of this disclosure, so that the non-transitory, computer-readable storage medium that stores the program code constitutes this disclosure. In addition, the program code can be supplied via a transmission medium, or the like, in which case the program code itself constitutes this disclosure. The storage medium in these cases can be, in addition to ROM, a floppy disk, a hard disk, an optical disc, a magneto-optical disk, a CD-ROM, a CD-R, a magnetic tape, a non-volatile memory card, or the like. The non-transitory, computer-readable storage medium includes storage media that retain programs for a set period of time, such as volatile memory (for example, Dynamic Random Access Memory (DRAM)) inside a computer system that constitutes a server or a client. when the program is transmitted via a network such as the Internet or a communication line, such as a telephone line.

According to one embodiment of this disclosure, it is possible to appropriately determine repetition of the same note.

What is claimed is:

1. A repetition determination device comprising:
an electronic controller including at least one processor, the at least one processor being configured to execute a plurality of units including
a first acquisition unit configured to acquire note-on events and a note-off event as note events corresponding to key operations,
a second acquisition unit configured to acquire a pedal-on event and a pedal-off event as pedal events corresponding to operations of a pedal having a function of sustaining sound, and
a determination unit configured to determine, based on a time interval between acquisition of a first note-on event and acquisition of a second note-on event, the note-off event, the pedal-on event, and the pedal-off event, whether the second note-on event corresponds to repetition of a same note with respect to the first note-on event, the first note-on event and the second note-on event being successive and related to the same note among the note-on events that have been acquired.

2. The repetition determination device according to claim 1, wherein
the determination unit is further configured to
determine, as a pedal-on state, a state in which the pedal-off event is not acquired after the pedal-on event is acquired, the pedal-on state corresponding to a state in which the pedal is being depressed, and
determine a state of the pedal other than the pedal-on state, as a pedal-off state corresponding to a state in which the pedal is not depressed, and
the determination unit is configured to determine that the second note-on event corresponds to the repetition, in response to the first acquisition unit acquiring, in the pedal-on state, the note-off event that occurs after the first note-on event, and acquiring the second note-on event, while the pedal-on state continues, before a prescribed period of time has elapsed since the first acquisition unit has acquired the first note-on event.

3. The repetition determination device according to claim 1, wherein
the determination unit is further configured to
determine, as a pedal-on state, a state in which the pedal-off event is not acquired after the pedal-on event is acquired, the pedal-on state corresponding to a state in which the pedal is being depressed, and
determine a state of the pedal other than the pedal-on state, as a pedal-off state corresponding to a state in which the pedal is not depressed, and
the determination unit is configured to determine that the second note-on event does not correspond to the repetition, in response to the first acquisition unit acquiring, in the pedal-on state, the note-off event that occurs after the first note-on event, and acquiring the second note-on event after a prescribed period of time has elapsed since the first acquisition unit has acquired the first note-on event.

4. The repetition determination device according to claim 1, wherein
the determination unit is further configured to
determine, as a pedal-on state, a state in which the pedal-off event is not acquired after the pedal-on event is acquired, the pedal-on state corresponding to a state in which the pedal is being depressed, and
determine a state of the pedal other than the pedal-on state, as a pedal-off state corresponding to a state in which the pedal is not depressed, and
the determination unit is configured to determine that the second note-on event does not correspond to the repetition, in response to the first acquisition unit acquiring, in the pedal-on state, the note-off event that occurs after the first note-on event, and acquiring the second note-on event after the pedal enters the pedal-off state.

5. The repetition determination device according to claim 1, wherein
the determination unit is configured to determine that the second note-on event corresponds to the repetition, in response to the first acquisition unit not acquiring, the note-off event after the first note-on event, and acquiring the second note-on event before the prescribed period of time has elapsed since the first acquisition unit has acquired the first note-on event.

6. The repetition determination device according to claim 1, wherein
the at least one processor is further configured to execute a sound control unit configured to, in response to the determination unit determining that the second note-on event corresponds to the repetition, regarding sound control based on the second note-on event, execute a prescribed sound control that is different from a sound control executed in response to the determination unit determining that the second note-on event does not correspond to the repetition.

7. The repetition determination device according to claim 6, wherein
the sound control unit is configured to execute the prescribed sound control based on at least one or more of a note number, a note-on velocity of the first note-on event, a note-on velocity of the second note-on event, or the time interval.

8. The repetition determination device according to claim 6, wherein
the sound control unit is configured to use a random number generated using a normal distribution to execute the prescribed sound control.

9. A repetition determination device comprising:
an electronic controller including at least one processor, the at least one processor being configured to execute a plurality of units including
an acquisition unit configured to acquire note-on events and a note-off event as note events corresponding to key operations;
a determination unit configured to determine whether a second note-on event corresponds to repetition of a same note with respect to a first note-on event, the first note-on event and the second note-on event being successive and related to the same note among the note-on events that have been acquired; and
a sound control unit configured to, in response to the determination unit determining that the second note-on event corresponds to the repetition, regarding sound control based on the second note-on event, execute a prescribed sound control that is different from a sound control executed in response to the determination unit determining that the second note-on event does not correspond to the repetition,
the sound control unit being configured to correct sound characteristics by using, in the prescribed sound control, a random number corresponding to a variance set based on a correction value.

10. A repetition determination method realized by a computer, the method comprising:
acquiring note-on events and a note-off event as note events corresponding to key operations;
acquiring a pedal-on event and a pedal-off event as pedal events corresponding to operations of a pedal having a function of sustaining sound; and
determining, based on a time interval between acquisition of a first note-on event and acquisition of a second note-on event, the note-off event, the pedal-on event, and the pedal-off event, whether the second note-on event corresponds to repetition of a same note with respect to the first note-on event, the first note-on event and the second note-on event being successive and related to the same note among the note-on events that have been acquired.

11. A non-transitory computer-readable medium storing a program that causes a computer to execute a repetition determination method, the method comprising:
acquiring note-on events and a note-off events as note events corresponding to key operations;
acquiring a pedal-on event and a pedal-off event as pedal events corresponding to operations of a pedal having a function of sustaining sound; and
determining, based on a time interval between acquisition of a first note-on event and acquisition of a second note-on event, the note-off event, the pedal-on event, and the pedal-off event, whether the second note-on event corresponds to repetition of a same note with respect to the first note-on event, the first note-on event and the second note-on event being successive and related to the same note among the note-on events that have been acquired.
